(19) United States
(12) Patent Application Publication
(10) Pub. No.: US 2026/0065239 A1
(43) Pub. Date: Mar. 5, 2026

(54) CHECK AUTHENTICATION SYSTEM AND OPERATION METHOD USING CHECK PAPER PRINTED WITH MICRO DOT PATTERNS AND SMART PEN

(71) Applicant: DABIDA CORP., Anyang-si (KR)

(72) Inventor: Eunseung LEE, Gwangju (KR)

(73) Assignee: DABIDA CORP., Anyang-si (KR)

(21) Appl. No.: 19/268,964

(22) Filed: Jul. 14, 2025

(30) Foreign Application Priority Data
Aug. 27, 2024 (KR) 10-2024-0115318

(51) Int. Cl. G06Q 20/04; G06K 7/14; G06Q 20/40; G06Q 40/02

(52) U.S. Cl. CPC G06Q 20/042; G06K 7/1408; G06Q 20/4037; G06Q 40/028

(57) ABSTRACT

A method for operating a check authentication system using a smart pen is disclosed. The method comprising: printing a uniquely identifiable micro dot pattern on a check paper, and storing a check image corresponding to the check paper in a server; recognizing the micro dot pattern using a smart pen; transmitting recognition information regarding the recognized micro dot pattern to the server; extracting and loading the stored check image, using the transmitted recognition information; generating check input information based on sensing information collected by the smart pen, while the check information is written on the check paper via the smart pen; transmitting the generated check input information to the server; entering the transmitted check input information on the loaded check image; transmitting the check image including the check input information to a recipient terminal; determining whether an agreement action is entered for the transmitted check image; and requesting a bank server to debit an account of a check issuer by an amount included in the check input information, when the agreement action is entered.

### CROSS-REFERENCE TO RELATED APPLICATIONS

A claim for priority under 35 U.S. C. § 119 is made to Korean Patent Application No. 10-2024-0115318 filed on Aug. 27, 2024, in the Korean Intellectual Property Office, the entire contents of which are hereby incorporated by reference.

### BACKGROUND OF THE INVENTION

### Field of the Invention

The present invention relates to a technology for processing check authentication based on agreement between a recipient and an issuer by using a check paper on which a uniquely identifiable micro dot pattern is printed and a check image that is matched with the check paper and includes check input information entered via a smart pen.

### Description of the Related Art

Personal checks still play an important role in financial transactions, but recent trends and technological advances have highlighted several issues.

Traditional check processing may often take several days, causing delays and uncertainty in the availability of funds. The time period required for the check to reach a bank and be processed can make it difficult for both an issuer (or a drawer) and a recipient (or a payee) to access the funds quickly. This may be particularly inconvenient in situations where the funds are needed urgently.

One of the current problems may arise when there are insufficient funds in an account when the check is cashed. If there are insufficient funds in the issuer's account, the check may be returned, which may be detrimental to both the issuer and the recipient. Insufficient funds undermine reliability of checks and cause instability in transactions. In addition, if the check is returned, both the issuer and the recipient may face penalties for bouncing the check.

Delays in the check processing provide opportunities for scammers or fraudsters to exploit. Physical checks can be stolen or tampered with, and there is a risk of forgery even with simple methods such as digital capture. In case of checks captured by cameras, a verification process takes place after the check is deposited, which can leave opportunities for fraudulent activity.

The processing time for checks captured by the cameras can still be delayed. Check images must be reviewed and verified by the bank, which can cause delays. Additionally, these checks may be processed in batches, leading to further delays in fund availability.

While capturing checks with the cameras offers convenience, users must manually capture each check image, and can cause errors during the capture. For example, captured images may be blurry or misaligned, and any additional steps are required to manually enter the check details.

Physical checks and their digital images are stored separately, which can complicate record keeping and auditing. Users and banks need to manually track and reconcile physical and digital records. These issues make it difficult to maintain accuracy and consistency of the records.

In the years 2020, 2022, and 2023, statistics related to check fraud have been in the spotlight. In 2020, financial losses from the check fraud exceeded $3.3 billion, and the FBI received over 791,790 reports of internet crimes. In 2022, there was a surge in suspicious activity reports (SARs) related to the check fraud, with total fraud losses reaching nearly $8.8 billion. In 2023, the fraud losses exceeded $10 billion, and the check fraud remains a significant problem.

These statistics suggest that traditional check usages still have many security and efficiency issues. Therefore, stronger fraud prevention measures and introduction of modern digital payment systems are needed.

### SUMMARY OF THE INVENTION

The present invention is contemplated to solve problems in the prior art mentioned above. Thus, it is an object of the present invention to significantly reduce check processing time by using a check that is issued and tracked in real time through a platform.

It is an object of the present invention to provide instant verification and transfer of funds.

It is an object of the present invention to reduce a risk of check bounce by ensuring that the check is issued only when sufficient funds are available, through real-time tracking and verification.

It is an object of the present invention to prevent fraudulent activities through instant issuance and verification.

To solve the above problems, according to a first aspect of the invention, the present invention may provide a method for operating a check authentication system using a smart pen, the method comprising: printing a uniquely identifiable micro dot pattern on a check paper, and storing a check image corresponding to the check paper in a server; recognizing the micro dot pattern using a smart pen; transmitting recognition information regarding the recognized micro dot pattern to the server; extracting and loading the stored check image, using the transmitted recognition information; generating check input information based on sensing information collected by the smart pen, while the check information is written on the check paper via the smart pen; transmitting the generated check input information to the server; entering the transmitted check input information on the loaded check image; transmitting the check image including the check input information to a recipient terminal; determining whether an agreement action is entered for the transmitted check image; and requesting a bank server to debit an account of a check issuer by an amount included in the check input information, when the agreement action is entered.

The operation method may further comprise transmitting a transaction hold request for the account of the check issuer to the bank server for an amount equal to the amount included in the check input information.

The operation method may further comprise: querying the bank server whether the account of the check issuer has a balance of no less than the amount included in the check input information, when the check image is received; and requesting the agreement action for the check image to the recipient terminal, only when the balance of no less than the amount included in the check input information exists.

The operation method may further comprise, if the balance of no less than the amount included in the check input information does not exist, deactivating the agreement action for the check image until the balance of no less than the amount included in the check input information exists.

The operation method may further comprise performing a void process on the check image, when the agreement action is entered and the amount included in the check input information is debited.

The printing of the micro dot pattern may include generating the micro dot pattern which is configured to uniquely identify the check paper by combining at least one of characteristic information for dots printed within a unit area or relationship information between neighboring dots within the unit area.

Meanwhile, according to a second aspect of the invention, the present invention may provide a check authentication system using a smart pen, the system comprising: a check authentication server configured to print a uniquely identifiable micro dot pattern on a check paper, and store a check image corresponding to the check paper; and a smart pen configured to recognize the micro dot pattern, wherein the smart pen is further configured to: transmit recognition information regarding the recognized micro dot pattern to the check authentication server; generate check input information based on sensing information collected by a sensor, while the check information is written on the check paper; and transmit the generated check input information to the check authentication server, wherein the check authentication server further configured to: extract and load the stored check image, using the transmitted recognition information; enter the transmitted check input information on the loaded check image; transmit the check image including the check input information to a recipient terminal; determine whether an agreement action is entered for the transmitted check image at the recipient terminal; and request a bank server to debit an account of a check issuer by an amount included in the check input information, when the agreement action is entered at the recipient terminal.

The check authentication server may be further configured to transmit a transaction hold request for the account of the check issuer to the bank server for an amount equal to the amount included in the check input information.

The check authentication server may be further configured to: query the bank server whether the account of the check issuer has a balance of no less than the amount included in the check input information, when the check image is received; request the agreement action for the check image to the recipient terminal, only when the balance of no less than the amount included in the check input information exists; and if the balance of no less than the amount included in the check input information does not exist, deactivate the agreement action for the check image until the balance of no less than the amount included in the check input information exists.

Details of examples or implementations will be described in the following with reference to the accompanying drawings. Other features will be apparent from the description and drawings, and from the claims.

### BRIEF DESCRIPTION OF THE DRAWINGS

The present invention will become more fully understood from the detailed description given below and the accompanying drawings, which are given by illustration only, and thus are not intended to limit the scope of the present Invention, wherein:

FIG. 1 is a schematic diagram illustrating a check authentication system using a smart pen, according to one embodiment;

FIG. 2 is a plan view illustrating a check paper printed with a micro dot pattern;

FIG. 3 is a schematic diagram illustrating an entry of check input information according to an operation of the smart pen;

FIG. 4 is a plan view illustrating the micro dot pattern printed on the check paper;

FIG. 5 is a flowchart illustrating an operation between a check authentication server and a smart pen; and

FIG. 6 is a flowchart illustrating an operation between a check authentication server and a recipient terminal.

### DETAILED DESCRIPTION OF THE PREFERRED EMBODIMENT

Description for the present invention will now be given in detail according to examples disclosed herein, with reference to the accompanying drawings.

For the sake of a brief description with reference to the drawings, the same or equivalent components may be provided with the same reference numbers, and description thereof will not be repeated. In the following, any conventional art which is well-known to one of ordinary skill in the relevant art has generally been omitted for the sake of brevity. The accompanying drawings are used to help easily understand various technical features and it should be understood that the examples presented herein are not limited by the accompanying drawings. As such, the present invention should be construed to extend to any alterations, equivalents, and substitutes in addition to those which are particularly set out in the accompanying drawings.

A singular representation may include a plural representation unless it represents a definitely different meaning from the context.

It will be understood that although the terms “first,” “second,” etc., may be used herein to describe various components, these components should not be limited by these terms. These terms are only used to distinguish one component from another component.

It should be understood that when a component is referred to as being “connected to” or “coupled to” another component, this component may be directly connected to or coupled to another component, or any intervening components may be present between the components. In contrast, when a component is referred to as being “directly connected to” or “directly coupled to” another component, there are no intervening components present.

Terms such as “comprise”, “include” or “have” are used herein and should be understood that they are intended to indicate an existence of several components, functions or steps, disclosed in the specification, and it is also understood that greater or fewer components, functions, or steps may likewise be utilized. Moreover, due to the same reasons, it is also understood that the present invention includes any combinations of features, numerals, steps, operations, components, parts and the like partially omitted from the related or involved features, numerals, steps, operations, components, and parts described using the aforementioned terms unless deviating from the intentions of the original disclosure.

Hereinafter, the embodiments will be described with reference to drawings. However, the scope of the present application is not intended to be limited or restricted by these embodiments. Identical reference numerals in each of the drawings refer to identical members.

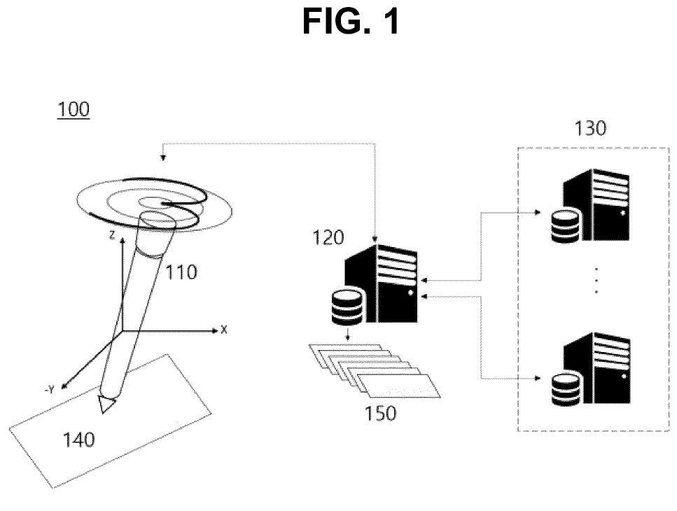

FIG. 1 is a schematic diagram illustrating a check authentication system 100 using a smart pen, according to one embodiment.

The check authentication system 100 according to one embodiment may significantly reduce check processing time by using checks that are issued and tracked in real time through a platform. In addition, with the check authentication system 100, instant verification and transfer of funds may be performed, and a risk of check bounces may be reduced by issuing the checks only when sufficient funds are available based on real-time tracking and verification, and fraudulent activities may be prevented from occurring through instant issuance and verification.

To this end, the check authentication system 100 may include a smart pen 110 and a check authentication server 120. In addition, the check authentication server 120 may interface with the bank server 130 to request information about an issuer of the check (i.e., a drawer, hereinafter referred to as “issuer”), such as an account balance, or to request that an amount equal to the amount written on the check be held in the check issuer's balance.

The check authentication server 120 may issue a check paper (or sheet) 140 in a physical form, and may generate a check image 150 corresponding to the check paper 140 and store the check image in a database. At this time, the check paper 140 and the check image 150 may be printed with a repeating micro dot pattern.

The micro dot pattern printed on or included in the check paper and the check image may uniquely identify the check paper by combining (or using) at least one of characteristic (or feature) information for the dots printed within a unit area or relationship information between neighboring dots within the unit area.

An optical identification (OID) sensor may be inserted into a pen tip of the smart pen 110, such that the check input information may be converted to digital information via a trajectory in which the smart pen 110 moves on the check paper 140 to input the check input information.

This digital information may be transmitted via the smart pen 110 to the check authentication server 120 so as to be printed or embedded as check input information on the check image 150.

That is, when the check issuer writes the check input information via the smart pen 110 on the printed check paper 140, the check authentication server 120 receiving the check input information in a digital format, loads the check image 150 that has been created and stored identically to the check paper 140, fills in or registers the check input information on the loaded check image 150, and digitalizes the check image into a completed check.

While the user enters the check input information on the check paper via the smart pen 110 as a handwriting, the smart pen 110 generates the check input information based on sensing information collected during the entering process.

The generated check input information is transmitted to the check authentication server 120, and then the server 120 receives the transmitted information and based on such information, performs an operation to record on the check image.

The check authentication server 120 uses the transmitted check input information to enter the corresponding information into the loaded check image.

The check image that contains the check input information is transmitted to a recipient terminal. The recipient terminal verifies the check image and, if necessary, requests approval, i.e., agreement, consent, or settlement between the issuer and a recipient (i.e., a payee, hereinafter referred to as “recipient”).

The recipient terminal may determine if an agreement or settlement action (hereinafter, referred to as “agreement action”) is entered for the transmitted check image.

The check authentication system using the smart pen as discussed above offers various advantages, and thus increases user convenience and security.

In terms of a risk of fraud, writing checks using the smart pen connected to the platform may significantly reduce the risk of fraud. Since the check information is stored directly in the bank's database, the risk of using a forged or stolen check is eliminated. Such a system is essential to ensure authenticity of checks.

Further, verification process of the present invention may be executed in real time. As soon as the check is drafted, the check may be authenticated thereby eliminating opportunity for fraudulent activity. Real-time verification allows the user to verify validity of the check from the moment the check is written, and thus provides immediate safety.

Immediate processing is also a major advantage. With real-time tracking and verification, the check is processed instantly, and this ensures immediate fund transfer and availability. The user may access funds quickly after drafting the check.

Continuous processing minimizes delays and improves efficiency. Continuous processing, which is managed digitally, may accelerate check transactions.

In terms of user effort, writing checks with the smart pen is as simple as using a traditional pen. Moreover, with added benefit of automatic digital recording, the user may avoid a cumbersome process of manual data entry.

The present invention automatically holds the check so that the check cannot be used normally if an amount of money contained in the check image is greater than the issuer's balance. This is an important feature which prevents the issuer from proceeding with the transaction due to insufficient funds. At this point, the system inspects the balance in the issuer's account, and if the amount of money of the check (hereinafter, briefly referred to as “amount of check,” “check amount,” or “amount”) exceeds the balance, transmits to the user a warning message “The amount of the check exceeds the balance and is not available for use.” In this way, the user may be immediately aware of the validity of the check and may avoid unnecessary transactions.

Alternatively, if the amount of the check is less than the issuer's balance, the system can still proceed with the holding. In this case, the system will reserve the amount of the check from the balance, so that such an amount of money (hereinafter, briefly referred to as “amount”) may be deducted when an actual transaction is executed. For example, if the issuer has a balance of $1,000,000 and the check amount is $500,000, the system will hold $500,000 from the balance so that the user may proceed with the transaction. The user is then notified that “The check amount has been successfully held” to confirm that the transaction is proceeding safely.

Such a manner of processing the holdings of the check and the amount increases the reliability of check transactions and effectively manages the balance of the issuer. Once the transaction is completed, the held amount is deducted from the issuer's balance, and the system updates the check's status. If the issuer's balance does not exceed the amount on hold, the user receives a low balance notification to encourage additional deposits.

In the end, this system plays a key role in increasing transparency of check transactions and providing the user with secure transaction experience.

With introduction of the automatic entry function, check details may be automatically recorded and stored in the bank's database. This reduces manual entry errors and effort. The automatic entry or input improves accuracy and minimizes user mistakes.

The check drafted with the smart pen is smoothly integrated into the bank's database, and ensures a single, consistent digital record. This process improves data management efficiency and maintains consistency of information.

Further, with the automatic tracking function, a digital record may be created automatically. The user may easily check the user's transaction history at any time, which further strengthens the reliability of financial transactions.

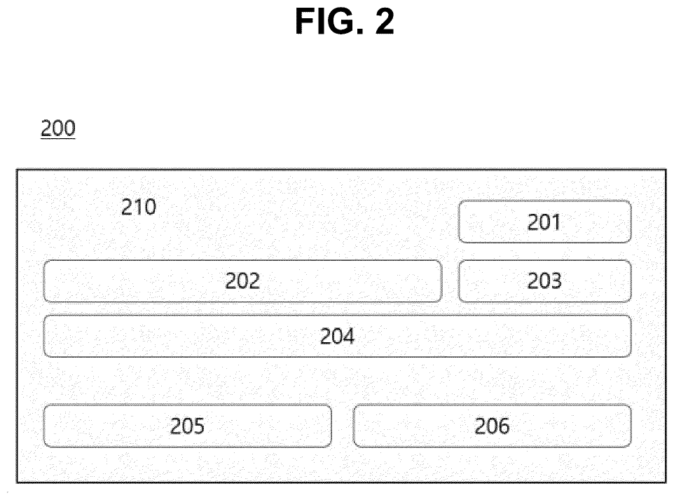

FIG. 2 is a plan view illustrating the check paper or check sheet on which the micro dot pattern is printed.

Reference numeral 201 denotes a check issue date, which should specify a date the check was issued. This is an important factor in determining the validity of the check.

Reference numeral 202 denotes a recipient's name, which should be written exactly as a name of person or organization to whom the check is made payable. If the recipient's name is incorrect, the recipient may have trouble in cashing the check.

Reference numeral 203 indicates the check amount (numbers), and reference numeral 204 indicates the check amount (letters), where the issuer must write the amount of the check in both numbers and letters. For example, both of “1,000,000” and “one million”are written to prevent misreading of the amount.

Reference numeral 205 corresponds to a purpose of the check, for example, in which a rent, a tuition or the like is written. Meanwhile, reference numeral 206 corresponds to the issuer's signature, which requires a signature of a person issuing the check. The signature certifies the validity of the check and indicates the issuer's consent.

In addition, each check may be given a unique check number, and may also include a name and branch information of the bank issuing the check or the bank account number of the issuer.

Meanwhile, the check paper is printed with the micro dot pattern to uniquely identify the check paper.

The micro dot pattern is printed on the check paper to provide unique identification information. The pattern includes small or fine dots printed within a specific unit area, each of which has a unique characteristic or feature.

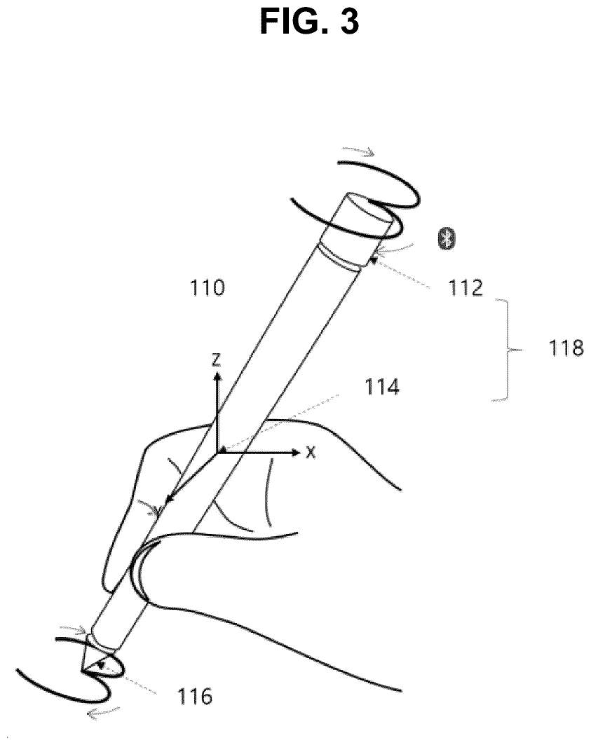

FIG. 3 is a schematic diagram illustrating an entry of check input information according to an operation of the smart pen 110.

The smart pen 110 according to one embodiment includes an IMU sensor 118, a gyro sensor 112, an acceleration sensor 114, and an OID sensor 116. The components for the smart pen 110 are not necessarily limited to these components.

The smart pen 110 uses USB power to charge an internal battery. The smart pen 110 communicates with an external device, such as a smartphone, using Bluetooth protocol. This allows the check input information to be transmitted to the server over a wired or wireless network.

The IMU sensor 118 is a configuration that includes the gyro sensor 112 and the acceleration sensor 114. The IMU sensor 118 is an inertial measurement unit sensor, meaning a six-axis sensor that includes three gyro axes and three acceleration axes.

The gyro sensor 112 senses an angular velocity, which is a rotational speed of an end of the pen as such an end moves to write the check input information on the check paper, and generates an angular velocity measurement. The gyro sensor 112 senses the angular velocity of a curvilinear motion of drag, a rotational motion, and a writing of characters “S,”“C,”“U”and the like while inputting the check information.

The acceleration sensor 114 is preferably, but not necessarily, provided at the tip of the pen. The acceleration sensor 114 includes a 3-axis acceleration sensor. The acceleration sensor 114 senses an acceleration at which a center of the pen moves in the pivot orientation for inputting the check information and generates an acceleration measurement. The acceleration sensor 114 senses a linear motion in a straight line when the check information is entered.

The OID sensor 116 is provided at the pen tip. The OID sensor 116 recognizes coordinates on the check paper via the embedded micro dot pattern printed on the check paper when the tip is moved to input the check information.

That is, the smart pen 110 utilizes the IMU sensor 118 to sense the movement, direction, and speed of the pen when entering the check information. When entering check information, the smart pen 110 uses the OID sensor 116 to recognize the coordinates of the dot and line data written on the check paper when the pen tip moves. The smart pen 110 recognizes the entry (i.e., the inputting or entering) of the check information based on a value sensed by the IMU sensor 118 and a value sensed by the OID sensor 116.

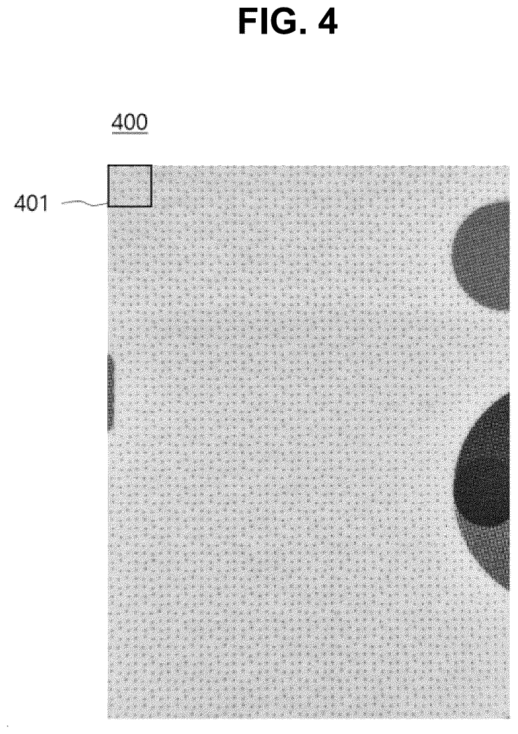

FIG. 4 is a plan view illustrating the micro dot pattern printed on the check paper 400.

The micro dot pattern is printed on the check paper or check sheet 400 to uniquely identify the check.

First, the micro dot pattern is printed on the check paper to provide unique identification information. Such a pattern comprises small or fine dots printed within a specific unit area 401, each of which has unique characteristic information. For example, a size, a shape, a color of each dot or a particular arrangement of the dots, etc. correspond to the unique characteristic information. This characteristic (or feature) information is combined with information about relationship between the dots within the space in which the dots are located, to create a unique pattern that allows the recognition or identification of the check paper.

Examples of such a micro dot pattern include dots that are spaced at specific intervals, or dots that are combined in a specific configuration. For example, dots in the shape of a square or triangle may be arranged in a specific formation, which acts like a unique code to recognize a specific check.

In this case, each pattern may contain important information such as the issuer, the issue date, the amount of the check, and so on by encrypting such information.

While the micro dot pattern is not easily recognized by the human eye, they may be recognized by specialized devices such as the smart pens. The smart pen may use built-in sensors and algorithms to detect this pattern and may accurately extract the check's information based on the data collected. This technology may enhance the security on the check and may verify the check in real-time while the user is drafting the check.

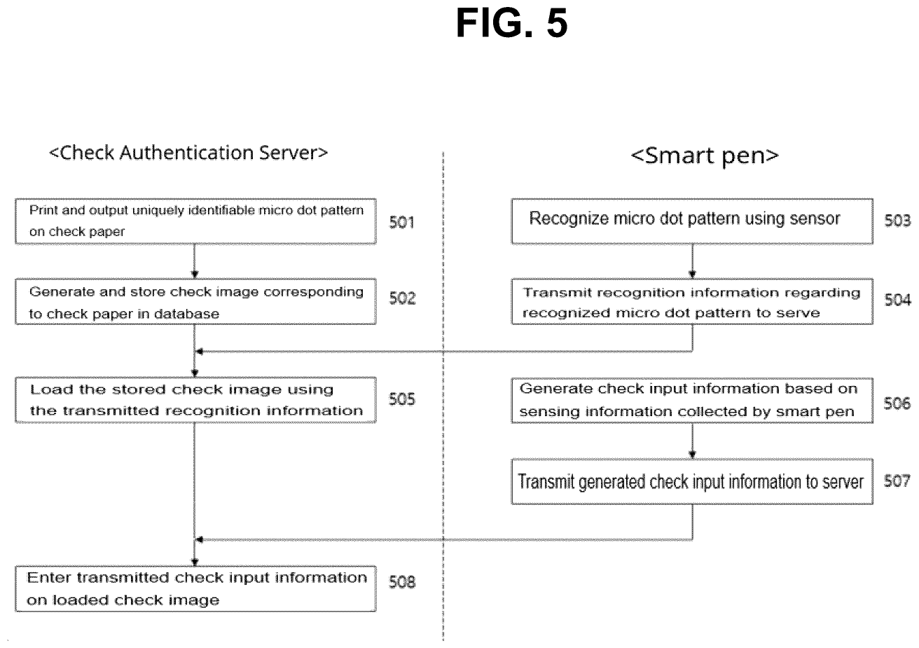

FIG. 5 is a flowchart illustrating the operation of the check authentication server and the smart pen.

The check authentication server prints a uniquely identifiable micro dot pattern on the check paper to output such a check paper (501).

For example, the server uses a specific algorithm to generate a unique pattern formed by the dots for each check and prints this unique pattern on the check paper. During this process, a printer prints the dots at a high resolution so that the dots may be recognized by the smart pen later. The pattern contains the check's issuance information, which helps prevent tampering or forgery.

The check authentication server stores the check image corresponding to the check paper in the database (502).

In this step, a front surface image and a back surface image of the check are scanned or photographed, converted to the digital form, and stored securely in the server's database. For example, the images are stored with the check's unique number, issue date, and recipient information so that the images may be combined with such information later.

The micro dot pattern is recognized using the smart pen (503).

When the user writes the check using the smart pen, the smart pen recognizes the micro dot pattern printed on the check paper. In this process, the smart pen's built-in sensors scan the pattern, and image processing algorithms analyze location and arrangement of the dots to extract the unique identification information. For example, if a specific pattern is recognized, the smart pen generates a unique ID for such a pattern.

The smart pen transmits recognition information regarding the recognized micro dot pattern to the server (504).

The smart pen forwards the information regarding the recognized micro dot pattern to the server. This information includes the unique ID of the pattern, as well as the time of recognition and the location information. For example, the smart pen may be connected to the server via Wi-Fi or Bluetooth to securely transmit the recognition information. In another example, the smart pen may be connected to the smartphone via near field communication to send relevant information to the server.

Using the transmitted recognition information, the check authentication server loads the stored check image (505).

Using the transmitted recognition information, the server loads the corresponding check image stored in the database. This step looks up and retrieves the corresponding check image from the database based on the unique ID received from the smart pen and loads the file or data of the image into memory. For example, the server searches for the image via a specific UUID and prepares to forward the image to the smart pen linked to the client.

While writing the check information on the check paper via the smart pen, the smart pen generates the check input information based on sensing information collected by the smart pen (506).

The smart pen collects the information (the recipient name, the amount, the signature, etc.) that the user enters, i.e., writes on the check paper in real time manner. During this process, the sensors detect the user's handwriting motion and a handwriting recognition algorithm converts the input data into the digital text. For example, a handwriting recognition technology is used to recognize “1,000,000” that is written by the user.

The smart pen transmits the generated check input information to the server (507).

This information includes the details of the check (e.g., the recipient name, the amount, the signature, etc.) and is communicated to the server via a secure communication protocol. For example, the information is transmitted in an encrypted form via HTTPS to ensure the safety of the data.

The transmitted check input information is written, i.e., added or recorded on the loaded check image (508).

The server writes or enters the transmitted check input information onto the loaded check image. This process places the recognized information in the correct locations on the check image to create the final check image. For example, the server completes the finalized check by overlaying the amount entered by the user and the recipient's name in the appropriate places on the image.

In one example, a transaction hold request to the account of the issuer of the check may be made to the bank server for an amount equal to the amount contained within the transmitted check input information.

After the agreement action is inputted by the recipient and the check issuer's account balance is confirmed to be not less than the amount of the check, the system (e.g., particularly, the check authentication server) prepares to request a transaction hold. At this time, the amount included in the check input information may be checked in advance. For example, if the check amount is $1,000,000, this amount is used for the transaction hold request.

The server of the check issuer (e.g., the check authentication server) sets up an API call to communicate with the bank server. This process includes any necessary authentication information to ensure that the request is made securely. For example, an OAuth token or API key is employed to access the bank server.

To use the check, the server sends or transmits the transaction hold request to the bank server, and waits for a response from the bank server. At this point, a timeout is set up so that if there is no response within a certain period of time, an error processing procedure may proceed. For example, if there is no response within 30 seconds, a message “Transaction hold request failed”may be delivered to the user.

If the transaction hold is successful, the system displays a message “Transaction is successfully on hold” to the user. Conversely, if it fails, an error message is delivered to the user.

After the transaction is on hold, the system manages the holding status. For example, a procedure may be implemented to automatically release the amount on hold when the check expires, or the recipient cancels the transaction. This process may be executed by checking the status with the bank server at regular intervals and updating the status as needed.

For example, when the check image is received, the bank server may be queried to determine whether the account of the check issuer has the balance of no less than the amount included in the check input information.

Further, only if the balance of no less than the amount included in the check input information exists, the agreement action for the check image is requested to the recipient terminal.

The recipient terminal receives the information related to the check image. This process verifies that the received check image is loaded correctly after the data transmission.

If the recipient terminal successfully receives the check image, the recipient terminal sends a query request to the bank server to confirm if the account of the check issuer has the balance of no less than the amount included in the check input information.

After receiving the request from the recipient, the bank server looks up the balance in the corresponding account. During this process, the bank server may access the database to check the balance of the issuer's account and compare the balance to the requested amount. For example, if the issuer's account has the balance of $1,500,000, the condition is satisfied.

The bank server responds to the recipient terminal with the result of the balance check. The response message contains relevant information about whether the required balance exists or not.

The recipient terminal analyzes the response and requests the agreement action (e.g., to the recipient) only if the balance is equal to or greater than the amount included in the check input information. If there is the sufficient balance, the recipient terminal may display the message that requests the user to take the agreement action. For example, a pop-up window asking, “Do you want to accept the check? ” may appear on the display.

If the user clicks an agreement button, the system requests the agreement to the bank server.

Such a series of steps check the check issuer's account balance in real time and provide the safe and reliable experience for the user.

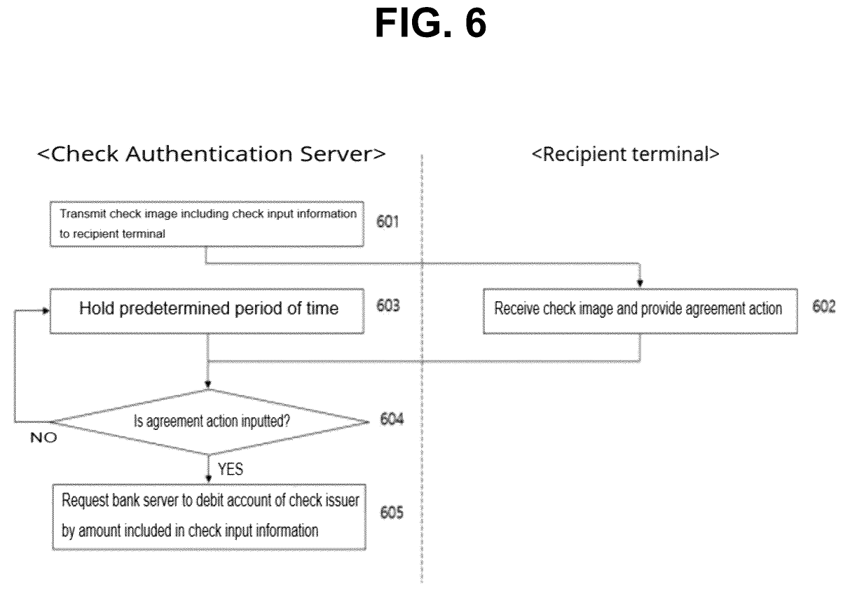

FIG. 6 is a flowchart illustrating an operation between the check authentication server and the smart pen.

The check authentication server transmits the check image including the check input information to the recipient terminal (601).

During this process, the issuer's server encrypts the data, including all information related to the check image, and transmits the encrypted data to the recipient terminal. For example, the image is transmitted in a format that may be viewed by the recipient via a smartphone application or a web application.

Upon receiving the check image with the check input information and verifying the check contents, the agreement action, such as pressing an agreement button and the like may be performed at the recipient terminal may perform (602).

If the amount less than the amount of the check is deposited in the issuer's account, the check image may be delivered with the agreement button disabled or inactivated. Further, as soon as the balance in the issuer's account becomes equal to or greater than the amount of the check, the agreement button may be changed to an enabled or activated state.

The recipient terminal displays the received check image on the screen and allows the user to check the contents of the check. After reviewing the recipient, the amount, the issue date, etc. of the check, the user may accept the check by clicking the “agreement” button in the user interface. For example, the recipient confirms the amount and the issuance information of the check and clicks the “agreement” button to indicate acceptance of the check.

If the check issuer's account has less funds than the amount of the check, the check image is delivered with the agreement button disabled or inactivated. At this stage, the system checks the issuer's account balance in real-time, and if the balance is insufficient, the agreement button is greyed out to be inactivated on the recipient terminal, so that the user cannot click the agreement button. For example, if the issuer's account balance is $500,000 and the check amount is $1,000,000, the agreement button will be disabled.

As soon as the balance in the issuer's account becomes equal to or greater than the amount of the check, the agreement button becomes active. For example, if the issuer deposits more funds and the account balance reaches $1,500,000, the agreement button may be activated and available for the user to click. This process takes place in real-time, and the system detects the balance change and immediately sends a notification to the user.

The recipient terminal determines whether the agreement action is entered for the above transmitted check image (604).

The recipient terminal determines whether the user has entered the agreement action. During this process, the system detects the user's input and determines whether the agreement button is clicked. For example, if the user clicks the agreement button after viewing the contents of the check, the system recognizes the action and proceeds to the next step.

If the agreement action is entered, the system (e.g., the check authentication server) requests the bank server to debit or deduct the account of the check issuer by the amount included in the check input information (605).

If the agreement action is entered, the request is made to the bank server to deduct the amount contained in the check input information from the account of the check issuer. In this step, the issuer's server sends the API request to the bank server to instruct the bank server to deduct the corresponding amount. For example, if the check amount is $1,000,000, the request may be sent to deduct such an amount from the issuer's account.

If, as a result of the determination in step 604, no agreement action is entered, the system (e.g., the check authentication server) may proceed to step 603 to hold the processing of the check for a predetermined period of time.

If no agreement action is inputted, the system holds the processing of the check for a period of time. During this process, the recipient terminal notifies the user that the processing of the check is being delayed and prompts the user to click the agreement button.

For example, the system holds the check processing for 10 minutes, after which the system automatically cancels the check or sends a notification for the user to reconfirm.

As such, the verification and processing of the check input information occurs in real time at each step, while increasing trust between the user and the bank and providing a secure transaction environment.

In one example, if the balance of no less than the amount included in the check input information is not present, the agreement action for the check image may be disabled or deactivated until the balance of no less than the amount included in the check input information is present.

The check authentication server may check the balance of the issuer's account based on the amount included in the check input information, and disable or inactivate the agreement action button if the balance is insufficient.

By the check authentication server, the agreement action button may be disabled in the user interface to prevent the user from attempting to request the agreement, or the user may be notified of the insufficient balance by displaying an insufficient balance message. For example, the warning message “Balance is insufficient. Please wait until the check amount is satisfied.” may be displayed.

The recipient terminal may implement a function to periodically check the balance of the issuer's account. For example, the recipient terminal could send a balance check request to the bank server at regular intervals (e.g., every 5 or 10 minutes).

If the balance increases up to the amount included in the check input information or more, the agreement button is re-enabled or reactivated, and the user is notified.

If the debit is successfully executed, the check authentication server performs a void process on the check image. The void process is a process indicating that the check is no longer valid.

The devices described herein may be implemented as hardware components, software components, and/or a combination of hardware and software components. For example, the devices and components described in the embodiments may be implemented using one or more general purpose computers or special purpose computers, such as, for example, a processor, controller, arithmetic logic unit (ALU), digital signal processor, microcomputer, field programmable array (FPA), programmable logic unit (PLU), microprocessor, or any other device capable of executing and responding to instructions. The processing device may include an operating system (OS) and one or more software applications executable on said operating system. The processing device may also access, store, manipulate, process, and generate data in response to the execution of the software. For ease of understanding, the processing device is sometimes described as utilizing a single processing element, but one of ordinary skill in the art will recognize that the processing device may include a plurality of processing elements and/or a plurality of types of processing elements. For example, the processing device may include a plurality of processors or one processor and one controller. Other processing configurations are also possible, such as parallel processors.

Software may include computer programs, code, instructions, or one or more combinations thereof, and may configure processing devices or instruct processing devices, independently or collectively, to operate as desired. The software and/or data may be permanently or temporarily embodied in any type of machine, component, physical device, virtual equipment, computer storage medium or device, or transmitted signal wave, to be interpreted by the processing device or to provide instructions or data to the processing device. Software may also be distributed on networked computer systems and stored or executed in a distributed manner. The software and data may be stored on one or more computer-readable recording media.

The methods according to embodiments may be implemented in the form of program instructions that may be executed through various computer means and recorded on a computer-readable medium. Said computer-readable medium may comprise program instructions, data files, data structures, and the like, singly or in combination. The program instructions recorded on said medium may be those specifically designed and configured for the embodiment or may be those known and available to those skilled in the art of computer software. Examples of computer-readable recording media include magnetic media, such as hard disks, floppy disks, and magnetic tapes; optical media, such as CD-ROMs and DVDs; magneto-optical media, such as floptical disks; and hardware devices specifically configured to store and execute program instructions, such as ROMs, RAMs, flash memory, and the like. Examples of program instructions include machine language code, such as that generated by a compiler, as well as high-level language code that can be executed by a computer using an interpreter or the like. The hardware device may be configured to operate as one or more software modules to perform the operations of the embodiments, and vice versa.

The system and method according to the present invention have the technical advantages as follows.

According to the embodiments of the present invention, the check processing time can be significantly reduced by using the check that is issued and tracked in real time through the platform.

According to the embodiments, the instant verification and transfer of funds can be performed.

According to the embodiments, the risk of check bounce can be reduced by ensuring that the check is issued only when sufficient funds are available, through real-time tracking and verification.

According to the embodiments, the fraudulent activities can be prevented through the instant issuance and verification.

Although a number of examples have been described, it should be understood that other modifications and implementations can be devised by those skilled in the art that will fall within the spirit and scope of the principles of the present invention. More particularly, various variations and modifications in the structure or the configuration are possible within the scope of the disclosure, the drawings, and the appended claims. In addition to variations and modifications in the configuration, alternative uses will also be apparent to those skilled in the art.

What is claimed is:

1. A method for operating a check authentication system using a smart pen, the method comprising:
printing a uniquely identifiable micro dot pattern on a check paper, and storing a check image corresponding to the check paper in a server;
recognizing the micro dot pattern using a smart pen;
transmitting recognition information regarding the recognized micro dot pattern to the server;
extracting and loading the stored check image, using the transmitted recognition information;
generating check input information based on sensing information collected by the smart pen, while the check information is written on the check paper via the smart pen;
transmitting the generated check input information to the server;
entering the transmitted check input information on the loaded check image;
transmitting the check image including the check input information to a recipient terminal;
determining whether an agreement action is entered for the transmitted check image; and
requesting a bank server to debit an account of a check issuer by an amount included in the check input information, when the agreement action is entered.

2. The method of claim 1, further comprising transmitting a transaction hold request for the account of the check issuer to the bank server for an amount equal to the amount included in the check input information.

3. The method of claim 1, further comprising:
querying the bank server whether the account of the check issuer has a balance of no less than the amount included in the check input information, when the check image is received; and
requesting the agreement action for the check image to the recipient terminal, only when the balance of no less than the amount included in the check input information exists.

4. The method of claim 3, further comprising, if the balance of no less than the amount included in the check input information does not exist, deactivating the agreement action for the check image until the balance of no less than the amount included in the check input information exists.

5. The method of claim 1, further comprising performing a void process on the check image, when the agreement action is entered and the amount included in the check input information is debited.

6. The method of claim 1, the printing of the micro dot pattern includes generating the micro dot pattern which is configured to uniquely identify the check paper by combining at least one of characteristic information for dots printed within a unit area or relationship information between neighboring dots within the unit area.

7. A check authentication system using a smart pen, the system comprising:
a check authentication server configured to print a uniquely identifiable micro dot pattern on a check paper, and store a check image corresponding to the check paper; and
a smart pen configured to recognize the micro dot pattern,
wherein the smart pen is further configured to:
transmit recognition information regarding the recognized micro dot pattern to the check authentication server;
generate check input information based on sensing information collected by a sensor, while the check information is written on the check paper; and
transmit the generated check input information to the check authentication server,
wherein the check authentication server further configured to:
extract and load the stored check image, using the transmitted recognition information;
enter the transmitted check input information on the loaded check image;
transmit the check image including the check input information to a recipient terminal;
determine whether an agreement action is entered for the transmitted check image at the recipient terminal; and
request a bank server to debit an account of a check issuer by an amount included in the check input information, when the agreement action is entered at the recipient terminal.

8. The system of claim 7, wherein the check authentication server is further configured to transmit a transaction hold request for the account of the check issuer to the bank server for an amount equal to the amount included in the check input information.

9. The system of claim 8, wherein the check authentication server is further configured to:
query the bank server whether the account of the check issuer has a balance of no less than the amount included in the check input information, when the check image is received;
request the agreement action for the check image to the recipient terminal, only when the balance of no less than the amount included in the check input information exists; and
if the balance of no less than the amount included in the check input information does not exist, deactivate the agreement action for the check image until the balance of no less than the amount included in the check input information exists.
